(19) United States
(12) Patent Application Publication
(10) Pub. No.: US 2006/0011818 A1
(43) Pub. Date: Jan. 19, 2006

(54) Optical element, method for manufacturing such an element and a method for aligning a light beam and such an element

(75) Inventor: Rudolf Johan Marie Vullers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/528,949

(22) PCT Filed: Sep. 23, 2003
(86) PCT No.: PCT/IB03/04187

§ 371 Date: Mar. 23, 2005

(30) Foreign Application Priority Data
Sep. 27, 2002 (EP) 02078999.6

(51) Int. Cl. H01J 40/14; G01J 3/50

(52) U.S. Cl. 250/226

(57) ABSTRACT

Optical element, provided with a receiving plane (10) comprising a receiving section (11) for receiving at least one light beam (2), wherein the receiving plane (10) is provided with at least one light-detection element (3) being arranged to detect whether at least part of said light beam is projected thereon. Further, the invention relates to a method for manufacturing an optical element, wherein the optical element substrate is provided with the at least one light-detection element, using at least one thin layer deposition technique.

The invention relates to an optical element.

Such an element is known from practice. The optical element can, for instance, comprise a lens, an optical grating, a slit, a diaphragm, an optical filter, an optical conductor such as a fibre optics cable, a mirror or a similar element. During use, the optical element is positioned in the path(s) of one or more light beams, for example in an optical system. Consequently, said light beam will be received by a receiving plane of the optical element, for instance by a plane comprising an outer surface of the optical element.

In case the optical element is a perfect optical mirror, said receiving surface can be a light reflecting surface of such an element.

If—on the other hand—the optical element is arranged to let at least part of the incoming light beam pass, for instance in case the optical element is a lens, an optical grating, a slit, a diaphragm, an optical filter or the like, the light beam may be received by various receiving planes of the optical element, said planes extending for example on a front side, a back side and/or within the optical element.

Normally, each light beam and each optical element of an optical system are aligned with respect to each other for a desired use. It may, for example, be desired to align the optical element and said laser beam precisely onto or relative to a certain optical axis of an optical system. The desired precision of the alignment can, for example, be on a micrometer scale. According to a known first method, alignment of the light beam and an optical element can be carried out by visual inspection. The respective positions of the light beam and the optical element can then be corrected manually, if required.

According to a known second method, each light beam and each optical element are aligned using characteristics of the part of said light beam which has passed the optical element. If the optical element is, for example, a diffraction element, a particular diffraction of the light beam is expected when the optical element and the light beam are aligned in a particular position. Consequently, such an optical element and a light beam can be aligned by observing the diffraction of the light beam effected by said optical element.

Both said aligning methods are rather cumbersome and time consuming, especially when an optical system comprises several optical elements which have to be aligned with respect to each other and with respect to at least one light beam. Furthermore, none of these methods will result in a desired high precision of alignment.

International application WO 02/31569 (Ohnstein et al.) discloses a micro-positioning system for accurately positioning an optical element relative to an optical device, such as a laser diode. The apparatus comprises a carrier which can be selectively moved in the X direction relative to a base. The optical element is coupled to said carrier, such that the optical element can be moved in the Y direction relative to said base. According to Ohnstein, the optical element is moved so that the light beam intersects a selected region of the optical element. The optical element preferably has different regions having different optical characteristics. Accordingly, the optical element will produce different optical results as the light beam is moved between said different regions. According to Ohnstein, this effect can be used in applications such as optical alignment.

Japanese patent application JP08005507 discloses a method and a device for optical axis alignment, wherein optical fibres are aligned using a laser beam. The fibres are aligned such that the transmission intensity of the laser light is at a maximum.

U.S. Pat. No. 4,871,250 (Koseki) relates to a laser beam monitor to detect the power and the mode pattern of a laser beam produced by a high power laser device. Said monitor comprises a beam intensity detection plate which is arranged to detect the localised intensity of a laser beam when the laser beam is projected thereon. The detected mode pattern of the laser beam is displayed on a CRT display. By referring to this display, an operator can adjust the alignment of a front mirror and the rear mirror of said laser device to correct or alter the mode pattern of the laser beam, if required. Consequently, Koseki utilizes said second method for aligning a light beam and optical elements, these elements being said front and rear mirror of the laser device.

It is an object of the present invention to solve the above-mentioned problems, so that, in particular, each optical element and each light beam can be aligned relatively fast and with relatively high precision with respect to each other.

The present invention provides an optical element, which is provided with a receiving plane comprising a receiving section for receiving at least one light beam, wherein the receiving plane is provided with at least one light-detection element being arranged to detect whether at least part of said light beam is projected thereon.

This optical element and said light beam can be aligned with relative ease with respect to each other, since the at least one light-detection element can provide precise information about the position wherein the light beam contacts the receiving plane of the optical element. Furthermore, depending on the nature of each detection element, said information can be obtained relatively fast and continuously during utilization of the optical element.

When the optical element and said light beam are properly aligned, the optical element receives the light beam in the receiving section of said receiving plane. The at least one detection element will detect whether at least part of the light beam is projected on that detection element. Detection can be achieved actively or passively by said element. Herein, active detection can involve the detection element producing a signal when it detects the light beam, for example in case the element comprises a thermocouple. Passive detection means that certain measurable characteristics of the detection element may change when the light beam is projected thereon, for instance in case the element comprises material having an electrical resistance which changes when light of said light beam is projected thereon.

The detection element can be arranged in several ways to acquire information concerning the relative positions of the incoming light beam and the optical element. According to a first embodiment, the at least one light-detection element is arranged adjacent said receiving section. In that case, the detection element will not detect the light beam if the beam and the optical element are properly aligned. On the other hand, if the light beam and the optical element are not properly aligned, the beam may be projected onto the at least one light detection element, so that this element can detect the beam's position in the receiving plane. In that case, the light beam and the optical element can be moved to a new respective position so that the beam is not projected on the at least one detection element anymore. Said movement can be carried out by hand and/or automatically, for instance, by a computer which receives data from the at least one detection element. The movement can comprise, for example, repositioning and/or redirecting the optical element and/or the light beam. This can e.g. be accomplished by one or more positioning systems known in the art.

Advantageously, in case each light-detection element is arranged adjacent said receiving section, the at least one light-detection element substantially surrounds at least part of said light receiving section of the receiving plane. As a result, the at least one light-detection element can detect on substantially all sides of the receiving section whether the light beam and the optical element are properly aligned. Preferably, said light receiving section part, being surrounded by said detection element, is only slightly larger than the cross-section of said light beam viewed in said receiving plane, so that said alignment can be very precise.

According to an alternative embodiment, the at least one light-detection element at least partially extends in said receiving section. In that case a certain part of the light beam will be projected onto the at least one detection element when the optical element and said beam are properly aligned. A change of alignment can result in each detection element detecting the light beam differently. In case such a change of alignment is not desired, the light beam and the optical element can be moved back to a relative position wherein they are properly aligned.

Further advantageous embodiments of the invention are described in the dependent claims.

The invention also relates to a method of manufacturing the optical element according to the invention as well as to a method of aligning at least one light beam and the optical element according to the invention.

Furthermore the invention relates to an optical device for recording and/or reproducing information on/from an information layer of a rotatable optical disc, such as a CD or DVD. The characterizing feature of the device according to the invention is the presence of at least one optical element according to the invention.

The invention will now be described in more detail on the basis of exemplary embodiments shown in the accompanying drawings.

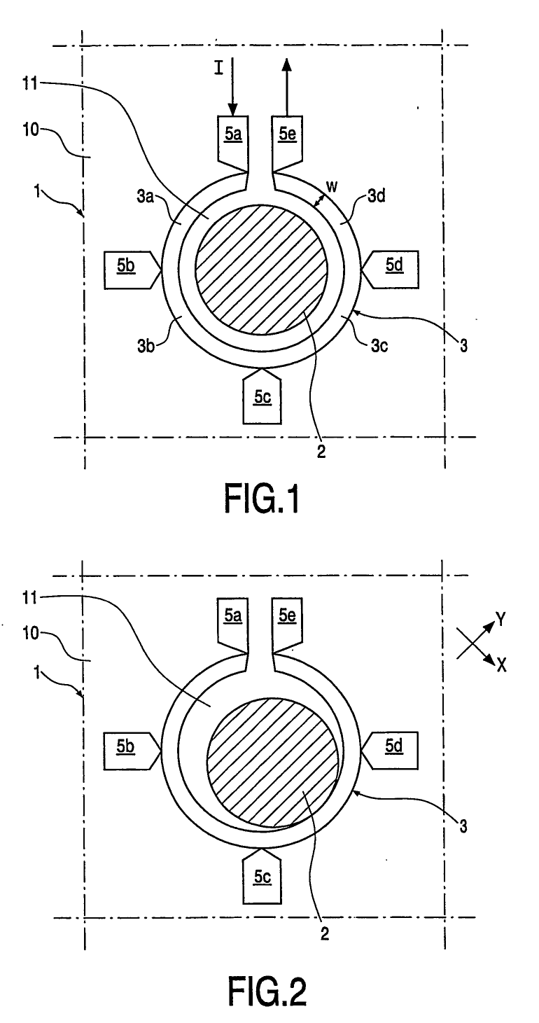

FIG. 1 is a top view of a first embodiment of the present invention, wherein the light beam and the optical element are in alignment;

FIG. 2 is a top view similar to FIG. 1, wherein the light beam and the optical element are out of alignment;

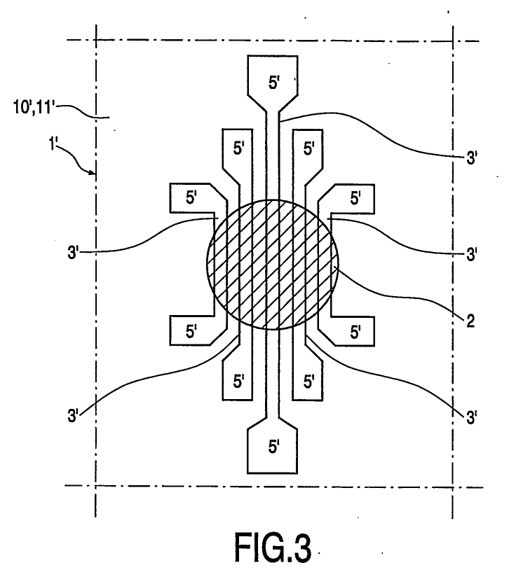

FIG. 3 is a top view of a second embodiment of the present invention; and

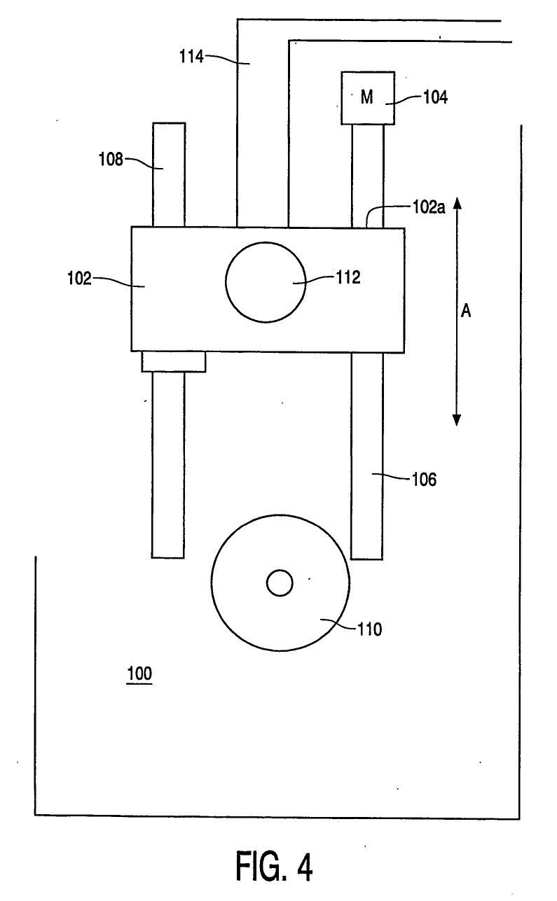

FIG. 4 is a schematic design of an embodiment of the optical device according to the invention.

FIG. 1 shows part of an optical element 1. The optical element 1 is provided with a receiving plane 10 for receiving a light beam 2. Said receiving plane 10 can, for instance, comprise an outer surface and/or an intersecting plane of the optical element 1. The receiving plane 10 comprises a circular receiving section 11 for receiving at least one light beam 2. In FIG. 1, the light beam 2 extends perpendicularly to the plane of drawing. Consequently, said beam 2 is shown in cross-section.

As is shown, the receiving plane 10 is provided with a relatively simple light-detection element 3 having the form of an interrupted ring. This detection element 3 substantially surrounds the light receiving section 11 within said receiving plane 10.

In the embodiment of FIG. 1, said detection element 3 is arranged adjacent said receiving section 11. The detection element 3 is arranged to detect whether at least part of said light beam 2 is projected thereon. To this end, said detection element 3 comprises material having an electrical resistance which changes when light of said light beam 2 is projected thereon. Such material may, for instance, comprise a metal, such as copper, an alloy and/or another suitable material.

Further, different parts of the detection element 3 are arranged to be connected to an electrical measurement device. To this end, the optical element 1 comprises five electrical connections, each of which is a contact sheet 5 extending in said receiving plane 11. Each contact sheet comprises electrically conductive material, such as a metal or a like material. The contact sheets 5 are electrically connected to an outer edge of the detection ring 3. Two of these contact sheets 5a, 5e are connected to the opposite ends of the detection element 3, respectively, said opposite ends abutting the interruption of the ring shaped detection element 3. A third contact sheets 5c is connected to the detection ring 3 at a location opposite said ring interruption. The remaining two contact sheets 5b, 5d are coupled to opposite sides of the detection element 3, at locations in between the positions of the other three contact sheets 5a, 5c, 5e. Consequently, viewed counterclockwise, ends of a first ring section 3a of the detection element 3 are connected to a first and a second contact sheet 5a, 5b respectively, ends of a second ring section 3b are connected to the second and a third contact sheet 5b, 5c respectively, ends of a third ring section 3c are connected to the third and a fourth contact sheet 5c, 5d respectively, and ends of a fourth ring section 3d are connected to the fourth and a fifth contact sheet 5d, 5e respectively. Said four ring sections 3a-3d are positioned symmetrically with respect to each other in the receiving plane 10.

The optical element 1 shown in FIG. 1 may be manufactured in different ways. According to the invention, it is advantageous if the optical element 1 has been provided with the light-detection ring 3 using at least one thin layer deposition technique, for example chemical vapour deposition (CVD), plasma-enhanced CVD (PE-CVD), molecular beam epitaxy (MBE), sputtering and/or evaporation. Using such a technique, the detection element 3 can be dimensioned with high precision. Depending on the applied technique, precisions on a nanometer scale can be achieved for the diameter of the detection element 3, the width W of this detection element 3 measured in said light receiving plane 10, and the thickness of this detection element 3 measured perpendicularly to said light receiving plane. Thus the volume of each ring section 3a-3e can be controlled with high precision during the manufacturing thereof, resulting in certain desired electrical characteristics of the detection element 3. Said electrical contact sheets 5 can be made together with the detection element 3. Further, the use of said techniques leads to the possibility of manufacturing relatively small detection elements 3, providing certain advantages which are mentioned below. Besides, thin layer deposition techniques are capable of manufacturing the detection element on many different types of optical elements. Moreover, the optical element 1 and the detection element may be manufactured together using one or more of such techniques. This is, for example, advantageous in case the optical element as such is of relatively small dimensions. Such small optical elements are, for instance, applied in high data density optical storage systems wherein smaller form factors are sought after.

When the light beam 2 and the optical element 1 of the first embodiment are properly aligned, the full light beam 2 intersects the circular receiving section 11 of the receiving plane 10 of the optical element 1. In that case, the electrical resistances of the ring sections 3a-3d of the detection element 3 will be substantially not affected by said light beam 2. In case the light beam 2 and the optical element 1 are out of alignment to a certain degree, part of the light beam will be projected onto the detection element 3, as is shown in FIG. 2. Then, the temperature of each ring section on which the light beam is incident will increase, resulting in a change of resistance of said ring section. For instance, if the detection element 3 comprises a metal, such as copper, the resistance of the ring section illuminated by the light beam 2 will increase.

Following from the above, the detection element 3 can be used to align the light beam 2 and the optical element 1 with respect to each other, so that the optical element 1 substantially receives the light beam 2 in the receiving section 11 of the receiving plane 10, resulting in the situation shown in FIG. 1. In the present embodiment, said use of the detection element 3 comprises measuring its resistance to detect whether at least part of the light beam 2 is projected thereon. For this purpose, an electric current I is applied to the detection element 3 by a current source, not shown, using the first and the fifth contact sheet 5a, 5e, said current I flowing through all of the ring sections 3a-3d. Further, the electric potentials V of each of the contact sheets 5a-5e are measured by a measurement device, which is not shown. In view of the previous paragraph, if the light beam 2 and the optical element 1 are properly aligned, the ring sections 3a-3d of the detection element 3 will have substantially equal resistances, resulting in the contact sheets 5a-5e having substantially equal electric potentials. On the other hand, if the light beam 2 and the optical element 1 are misaligned in an x-direction as is shown in FIG. 2, wherein part of the light beam illuminates the third ring section 3c, the resistance of this third ring section 3c will change, resulting in a change of the potential difference between the adjoining third and fourth contact sheets 5c, 5d. This potential difference will be measured by said measurement device. Then, the light beam 2 and the optical element 1 can be realigned, for example manually and/or automatically, to counteract the observed potential change so that the light beam 2 is not projected on the detection element 3 anymore. For instance, in case a certain temperature rise of the detection element 3 has been detected, the light beam 2 and the optical element 1 are moved such that the temperature of said detection element 3 falls.

From the above it follows that the light beam 2 and the optical element 1 can be aligned and/or realigned by moving the light beam 2 and the optical element 1 from a first relative position, in which the light beam 2 is detected by the at least one light-detecting element 3, to a second relative position in which the light beam 2 is substantially not detected by said detecting element 3. FIG. 2 shows a possible first position in which there is a misalignment in the x-direction, while FIG. 1 shows a possible second position after realignment in the x-direction. The precision of the alignment can be improved by subsequently scanning or moving the light beam 2 and the optical element 1 to a third relative position in which the light beam 2 is detected again by the at least one light-detecting element 3. The third position may, for instance, be obtained after a further relative movement in the x-direction and/or a relative movement in the y-direction. Then, a final relative position of the light beam 2 and the optical element 1 can be determined using the detection results obtained for the first, second and third relative positions, for example by taking the average of observed relative positions wherein the light beam 2 was just detected by the light detection element 3.

Advantageously, the light-detection element 3 has a relatively small volume so that this element 3 can heat up relatively fast when it is illuminated by the light beam 2, so that the described alignment procedure can be carried out relatively fast with a specific accuracy. For example, said volume may be less than about 10,000 μm³. Further, to improve the accuracy of the obtainable alignment, said light receiving section part, which is at least partially surrounded by said detection element 3, is preferably only slightly larger than the cross-section of said light beam 2, viewed in said receiving plane 10. Further, said light-detection element 3 may have a relatively small thickness measured perpendicularly to said light receiving plane (x,y), for instance a thickness of about 100 μm or less, in particular about 1 μm or less or even about 100 nm or less. The width W of the detection element 3 can also be relatively small, such as a width of about 1 mm or less, particularly a width W smaller than about 100 μm, or a width W smaller than about 1 μm.

FIG. 3 shows an alternative embodiment of the invention, comprising an optical element 1′ having a number of detection elements 3′ which extend at least partially within a light receiving section 11′ of a receiving plane 10′. These detection elements comprise parallel spaced apart metal strips 3′, each of which is provided with two contact sheets 5′ on its opposite ends. During use, current-voltage measurements can be carried out on said detection strips 3′ using said contact sheets 5′ to detect whether the light beam 2 is projected on said strips 3. The light beam 2 and optical element 1 can be realigned in case the light beam 2 is not projected as desired. In this embodiment, the detection strips 3′ may have further functions besides being light detectors used for aligning. For instance, the strips 3′ can be dimensioned such that they serve as an optical grating providing a certain diffraction of the light beam 2.

Although the illustrative embodiments of the present invention have been described in greater detail with reference to the accompanying drawings, it is to be understood that the invention is not limited to those embodiments thereof. Various changes or modifications may be effected by one skilled in the art without departing from the scope or the spirit of the invention as defined in the claims.

For instance, the optical element may be provided with at least two spaced apart light-detection elements 3. The distance between the at least two detection elements may, for instance, be slightly larger than the diameter of said light beam, said diameter being measured in said receiving plane, so that a relatively precise alignment of the light beam and the optical element with respect to each other can be carried out. The difference between said distance and said light beam diameter can, for instance, be less than about 1 mm, in particular less than about 1 μm.

Further, the alignment of the at least one optical element and the at least one light beam can be made with reference to a certain object, axis, point line, plane or such. According to a further embodiment, each light beam and each optical element are aligned on an optical axis, for example an optical axis of an optical system.

Besides, each light-detection element 3 may comprise several types of material, such as a metal, an alloy, a photoconductive material, other types of material or a combination of said materials. The detection element may comprise at least one thermocouple being able to generate an electric signal relating to its temperature. It is advantageous if the detection element is arranged to heat up when at least part of said light beam is projected thereon, since the heat change is detectable with relatively inexpensive, easily implementable means. Further, this material is preferably able to withstand high power light beams, such as laser light beams.

Further, the optical element can comprise a lens, an optical filter, an optical grating, an optical conductor, such as an optical fiber, and/or another optical element.

When using thin layer deposition techniques for manufacturing the at least one detection element, several steps can be applied as is known to the skilled person, such as mask-production, photo-resist application, illumination, etching, resist removal, layer deposition, and/or other steps, to be carried out in a sequence suitable to the respective deposition techniques(s).

Further, when detecting a temperature of a detection element using voltage-current measurements, direct and/or alternating current can be utilized.

Besides, the optical element 1 can comprise one or more receiving planes, having different forms, such as flat, curved, and/or other shapes. In case the optical element comprises several receiving planes comprising at least one detection element, these planes may for instance extend parallel and/or in different directions with respect to each other, and be adjacent to and/or spaced apart from each other.

In case the optical element 1 comprises at least two receiving planes, each one of which comprises at least one light detection element, the light beam's direction and the optical element's orientation can also be aligned with respect to each other. Further, such an alignment can be achieved by providing an optical element comprising several receiving planes, wherein at least one light detection element extends through all of these receiving planes, for example parallel with respect to a desired path of the at least one light beam.

Furthermore, each receiving plane may receive at least one light beam from a surrounding area and/or from the inside of the optical element

Besides, each of the receiving planes may comprice more than one receiving area for receiving the at least one light beam. Also, one light receiving area may be used to receive more than one light beam.

Further, each optical element 3 may be formed, shaped, and/or dimensioned in many different ways.

The optical element according to the invention may be applied in many different types of optical systems, such as alignment systems, for instance when aligning optical fibres with each other. Other applications are for example optical switching and optical scanning devices, optical storage devices et cetera.

The embodiment of the device according to the invention shown in FIG. 4 is an optical storage device, particularly a disc player. The device has a frame 100 and comprises an optical pickup unit 102, a motor 104, a lead screw 106, a guide shaft 108 and a turntable 110.

The optical pickup head 102 can move along a direction indicated by the double headed arrow A hereafter also called the traverse direction between an innermost position and an outermost position with respect to a disc, such as a data disc, for instance a CD or a DVD, placed in the device. The guide shaft 108 extends along the traverse direction. The optical pickup head 102 has a portion engaging the guide shaft 108. The optical pickup head 102 is guided by the guide shaft 108 during its movement in the traverse direction.

The optical pickup head 102 includes an engagement portion 102a having a threaded hole through which the lead screw 106 extends.

The engagement portion 102a meshes with the lead screw 106. The lead screw 106 is coupled to an output shaft of the traverse motor 104 via a gear train so that the lead screw 106 can be rotated by the motor 104. As the lead screws 106 rotates, the optical pickup head 102 moves in the traverse direction.

A disc is, in operation, held in position on the turntable 110, which is driven by an electric motor not shown.

The optical pickup head 102 is provided with an objective lens 112 being an embodiment of the optical element according to the invention. A light beam is indicated by 114. The device is further provided with the usual optical means and electronic means. One or more of these optical means may be an optical element of the invention, too.

1. Optical element, provided with a receiving plane (10) comprising a receiving section (11) for receiving at least one light beam (2), wherein the receiving plane (10) is provided with at least one light-detection element (3) being arranged to detect whether at least part of said light beam is projected thereon.

2. Optical element according to claim 1, wherein the at least one light-detection element (3) is arranged adjacent said receiving section (11).

3. Optical element according to claim 1, wherein the at least one detection element (3) comprises material whose electric resistance changes when light of said light beam (2) is projected thereon, wherein said detection element (3) is arranged to be connected to an electrical measurement device.

4. Optical element according to claim 1, wherein the at least one light-detection element (3) substantially surrounds at least part of said light receiving section (11) of the receiving plane (10).

5. Optical element according to claim 4, wherein the at least one detection element (3) is a substantially ring-shaped.

6. Optical element according to claim 4, wherein said light receiving section, which is at least partially surrounded by said detection element (3), is only slightly larger than the cross-section of said light beam (2) viewed in said receiving plane (10).

7. Optical element according to claim 1, wherein said at least one detection element (3) is arranged symmetrically with respect to said light-receiving section (11).

8. Optical element according to claim 1, wherein said receiving plane (10) is provided with at least two spaced apart light-detection elements (3).

9. Optical element according to claim 8, wherein the distance between the at least two detection elements (3) is slightly larger than the diameter of said light beam (2), said diameter being measured in said receiving plane (10).

10. Optical element according to claim 9, wherein the difference between said distance and said light beam diameter is less than about 1 mm.

11. Optical element according to claim 9, wherein the difference between said distance and said light beam diameter is less than about 1 μm.

12. Optical element according to claim 1, wherein the optical element (1) has been provided with the at least one light-detection element (3) using at least one thin layer deposition technique, for example CVD, PE-CVD, MBE, sputtering and/or evaporation.

13. Optical element according to claim 1, wherein the at least one light-detection element (3) has a thickness, measured perpendicularly to said light receiving plane (x,y), of about 100 μm or less.

14. Optical element according to claim 13, wherein said thickness is about 1 μm or less.

15. Optical element according to claim 14, wherein said thickness is about 100 nm or less.

16. Optical element according to claim 1, wherein each light-detection element (3) has a width (W), measured in said light receiving plane (10), of about 1 mm or less

17. Optical element according to claim 16, wherein said width (W) is smaller than about 100 μm.

18. Optical element according to claim 16, wherein said width (W) is smaller than about 1 μm.

19. Optical element according to claim 1, wherein each light-detection element (3) has a volume of less than about 10,000 μm³.

20. Optical element according to claim 1, wherein the at least one light-detection element (3) comprises at least one electrically conductive material, for instance a metal.

21. Optical element according to claim 1, wherein the at least one light-detection element (3) comprises at least one thermocouple.

22. Optical element according to claim 1, wherein the optical element (1) comprises electrical connections (4) which are connected to the at least one light-detection element (3) to connect said detection element to a measurement device.

23. Optical element according to at least claim 3, wherein different parts of each light detection element (3) are arranged to be connected to an electrical measurement device.

24. Optical element according to at least claim 1, wherein the at least one detection element (3) extends at least partially within said receiving section (11).

25. Optical element according to claim 24, wherein the at least one light-detection element (3) is arranged to provide an optical grating.

26. Optical element according to claim 1, wherein the optical element (1) comprises a lens.

27. Optical element according to claim 1, wherein the optical element (1) comprises an optical filter.

28. Optical element according to claim 1, wherein the optical element (1) comprises an optical grating.

29. Optical element according to claim 1, wherein the optical element (1) comprises a mirror.

30. Method of manufacturing an optical element, wherein an optical element substrate is provided with the at least one light-detection element (3) using at least one thin layer deposition technique.

31. Method of aligning at least one light beam and an optical element according to claim 1, wherein the light beam (2) is projected onto said optical element (1), such that the optical element (1) receives the light beam (2) in said receiving plane (10), wherein the at least one light-detection element (3) is used to align the optical element (1) and the light beam (2) such, that the optical element substantially receives the light beam (2) in the receiving section (11) of the receiving plane (10).

32. Method according to claim 31, wherein the light beam (2) and the optical element (1) are moved from a first relative position in which the light beam (2) is detected by the at least one light-detecting element (3), to a second relative position in which the light beam (2) is substantially not detected by said detecting element (3).

33. Method according to claim 32, wherein subsequently the light beam (2) and the optical element (1) are moved to a third relative position in which the light beam (2) is detected again by the at least one light-detecting element (3) and/or by a further light-detecting element (3), wherein a final relative position of the light beam and the optical element (1) is determined using the detection results obtained for the first, second and third relative positions.

34. Method according to claim 31, characterized that the at least one light beam and the optical element (1) are aligned on an optical axis.

35. Method according to claim 3, wherein said use of the at least one detection element (3) comprises measuring its resistance to detect whether at least part of the light beam is projected thereon.

36. Method according to claim 35, wherein, when a certain temperature rise of the at least one detection element (3) is detected, the light beam (2) and the optical element are moved with respect to each other such that the temperature of said detection element (3) falls.

37. An optical device for recording and/or reproducing information on/from an information layer of a rotatable optical disc, which device comprises the optical element according to claim 1.
